(19) United States
(12) Patent Application Publication
(10) Pub. No.: US 2015/0046510 A1
(43) Pub. Date: Feb. 12, 2015

(54) THIRD PARTY SHARING-INFORMATION SEVER AND METHOD AND SYSTEM FOR GENERATING PERSONALIZED WEB PAGE THROUGH THE THIRD PARTY SHARING-INFORMATION SEVER

(71) Applicant: AVerMedia TECHNOLOGIES, INC., NEW TAIPEI CITY (TW)

(72) Inventor: Jui-Hung KAO, TAIPEI HSIEN (TW)

(73) Assignee: AVerMedia TECHNOLOGIES, INC., NEW TAIPEI CITY (TW)

(21) Appl. No.: 13/959,751

(22) Filed: Aug. 6, 2013

(51) Int. Cl. H04L 29/08

(52) U.S. Cl. CPC H04L 67/02; H04L 67/20
USPC 709/203

(57) ABSTRACT

The present invention discloses a method for generating a personalized web page through a third party sharing-information server, and the method includes: a third party sharing-information server receives a first information request for updating a user's preference profile. The third party sharing-information server transmits the updated user's preference profile to a first web server. The first web server transmits a first web page to the user according to the updated user's preference profile and a first web page request. The third party sharing-information server receives a second information request for updating the user's preference profile. The third party sharing-information server transmits the updated user's preference profile to a second web server. A second web server transmits a second web page to the user according to the updated user's preference profile and a second web page request.

### BACKGROUND

1. Technical Field

The present invention relates to a sharing-information server method, system and server. More particularly, the present invention relates to a third party sharing-information server and a method and a system for generating a personalized web page through the third party sharing-information server.

2. Description of Related Art

As network technology becomes popular, increasingly various contents are published on Internet each day. All the websites (such as video/audio sharing websites, shopping websites, bid websites, etc.) have the intention to find out what is users' preference, so as to provide finely personalized contents to attract the users.

Accordingly, the websites maintain records of users' preference profiles. Such preference profile may include users' browsing histories, users' purchase records, users' searching histories, EventTags from users, users' score etc. By analyzing the users' preference profiles, the websites can provide personalized search results and contents in web pages. Hence, the users can browse contents of interest more easily, and the websites can recommend advertisements that are more possibly interested by the users.

Since the websites maintain their own records of users' preference profiles separately, each of them can access its own records of users' preference profile, which limits depths and scopes of the users' preference profiles, so as to reduce possibility of customized contents.

### SUMMARY

According to one embodiment of this invention, a method for generating a personalized web page through a third party sharing-information server is disclosed. The method for generating a personalized web page through a third party sharing-information server includes the following step. An user operates a first client device to utilize identification information to log in a first web server and to transmit a first web page request to the first web server. A third party sharing-information server receives a first information request. The first information request is received from the user or the first web server, and the first information request includes the first web page request and the identification information. The third party sharing-information server updates the user's preference profile according to the first information request. The third party sharing-information server transmits the updated user's preference profile to the first web server. The first web server transmits a first web page to the user according to the updated user's preference profile and the first web page request. The user operates a second client device to utilize the identification information to log in a second web server and to transmit a second web page request. The first client device and the second client device are referred to as one single device or two independent devices. The third party sharing-information server receives a second information request. The second information request is received from the user or the second web server, and the second information request includes the second web page request and the identification information. The third party sharing-information server updates the user's preference profile according to the second information request. The third party sharing-information server transmits the updated user's preference profile to the second web server. The second web server transmits a second web page to the user according to the updated user's preference profile and the second web page request.

According to another embodiment of this invention, a system for generating a personalized web page through a third party sharing-information server is disclosed. The system includes a first web server, a second web server and a third party sharing-information server. The third party sharing-information server builds connections with the first web server and the second web server. The first web server connects to a network. A user operates a first client device to utilize identification information to log in the first web server and to transmit a first web page request to the first web server through the network. The second web server connects to the network. The user operates a second client device to utilize the identification information to log in the second web server and to transmit a second web page request to the second web server through the network. The first client device and the second client device are referred to as one single device or two independent devices. The third party sharing-information server includes a database, an information receiving module and an update module. The information receiving module receives a first information request and a second information request. The first information request is received from the user or the first web server, and the first information request includes the first web page request and the identification information. The second information request is received from the user or the second web server, and the second information request includes the second web page request and the identification information. The update module updates the user's preference profile stored in the database according to the first information request and transmits the updated user's preference profile to the first web server, such that the first web server transmits a first web page to the user according to the updated user's preference profile and the first web page request. The update module updates the user's preference profile according to the second information request and transmits the updated user's preference profile to the second web server, such that the second web server transmits a second web page to the user according to the updated user's preference profile and the second web page request.

According to another embodiment of this invention, a third party sharing-information server is disclosed. The third party sharing-information server includes a database, an information receiving module and an update module. The third party sharing-information server builds connections with a first web server and a second web server. A user operates a first client device to utilize identification information to log in the first web server and to transmit a first web page request to the first web server. The user operates a second client device to utilize the identification information to log in the second web server and to transmit a second web page request to the second web server. The first client device and the second client device are referred to as one single device or two independent devices. The information receiving module receives a first information request and a second information request. The first information request is received from the user or the first web server, and the first information request includes the first web page request and the identification information. The second information request is received from the user or the second web server, and the second information request includes the second web page request and the identification information. The update module updates the user's preference profile stored in the database according to the first information request and transmits the updated user's preference profile to the first web server, such that the first web server transmits a first web page to the user according to the updated user's preference profile and the first web page request. The update module updates the user's preference profile according to the second information request and transmits the updated user's preference profile to the second web server, such that the second web server transmits a second web page to the user according to the updated user's preference profile and the second web page request.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a flow diagram of a method for generating a personalized web page through a third party sharing-information server according to one embodiment of this invention; and

FIG. 2 illustrates a block diagram of a system for generating a personalized web page through a third party sharing-information server according to an embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

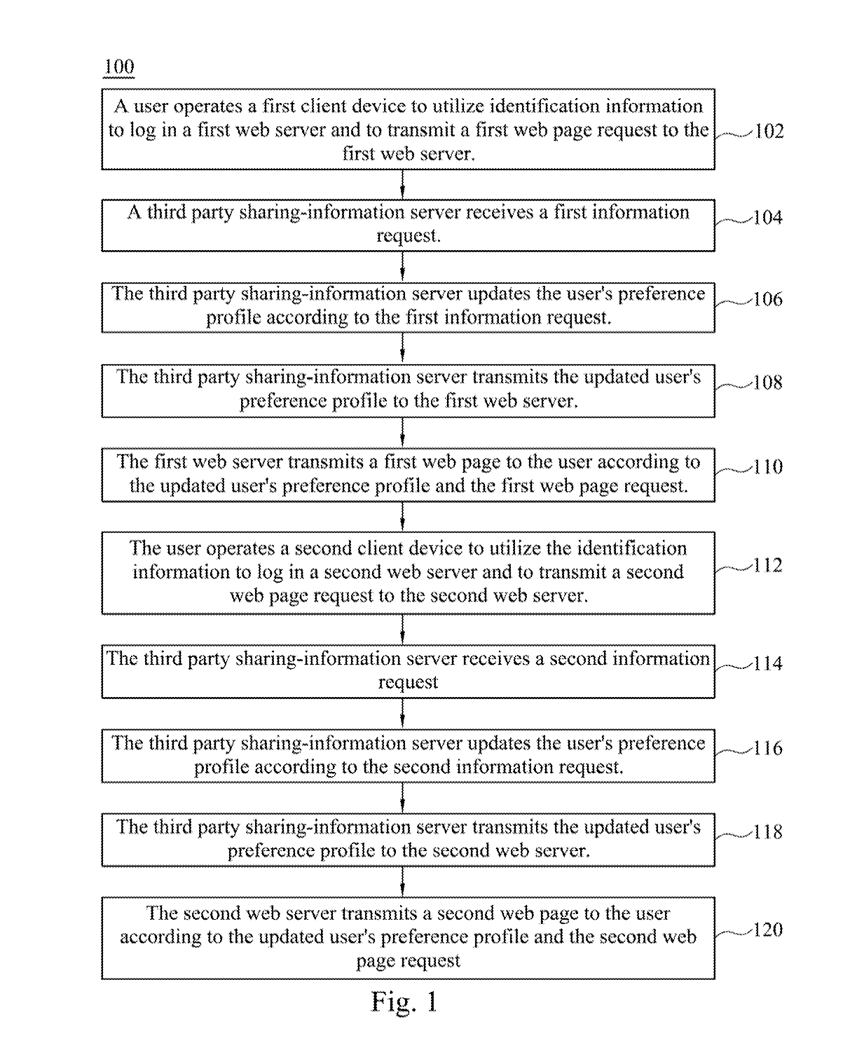

Referring to FIG. 1, a flow diagram will be described that illustrates a method for generating a personalized web page through a third party sharing-information server according to one embodiment of this invention. The method for generating a personalized web page through a third party sharing-information server may take the form of a computer program product stored on a non-transitory computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HDD) and floppy disk drives. The method for generating a personalized web page through a third party sharing-information server includes the following steps:

At step 102, a user operates a first client device to utilize identification information to log in a first web server and to transmit a first web page request to the first web server. In other words, when a user wants to access a web page provided by the first web server, the user can operate the first client device to transmit a corresponding first web page request (step 102), such that the first web server receives the first web page request. The identification information may include an email account of the user, a telephone number of the user, an International Mobile Equipment Identity (IMEI) number of the first client device, a network address of the first client device, or a network hardware address of the first client device or combination thereof. The network address of the first client device may include an Internet Protocol (IP) address of the first client device or any other type of the network address of the first client device. The network hardware address of the first client device may include a Media Access Control (MAC) address of the first client device or any other type of the network hardware address of the first client device.

At step 104, a third party sharing-information server receives a first information request. The first information request is received from the first client device operated by the user or the first web server. The first information request includes the first web page request and the identification information.

At step 106, the third party sharing-information server updates the user's preference profile according to the first information request.

At step 108, the third party sharing-information server transmits the updated user's preference profile to the first web server.

Subsequently, at step 110, the first web server transmits a first web page to the first client device operated by the user according to the updated user's preference profile and the first web page request. Therefore, the first web page transmitted at step 110 can fit the user's need.

At step 112, the user operates a second client device to utilize the identification information to log in a second web server and to transmit a second web page request to the second web server. The first client device and the second client device are referred to as one single device or two independent devices. In other words, when the user wants to access a web page provided by the second web server, he/she can operate the same client device or another client device to transmit a corresponding second web page request (step 112), such that the second web server receives the second web page request. The identification information for logging in at step 112 may include an email account of the user, a telephone number of the user, an IMEI number of the second client device, a network address of the second client device, or a network hardware address of the second client device. The first web server and the second web server are different servers. In some embodiments of this invention, the first web server and the second web server are different servers in different domains. In some other embodiments of this invention, the first web server and the second web server are different servers, which provide different web page services.

At step 114, the third party sharing-information server receives a second information request. The second information request is received from the second client device operated by the user or the second web server, and the second information request includes the second web page request and the identification information.

At step 116, the third party sharing-information server updates the user's preference profile according to the second information request.

At step 118, the third party sharing-information server transmits the updated user's preference profile to the second web server.

Subsequently, at step 120, the second web server transmits a second web page to the second client device operated by the user according to the updated user's preference profile and the second web page request. Therefore, even if the first web server and the second web server do not transmit received web page requests to each other, they can provide web pages, which fit users' favorite, with the assistance of the third party sharing-information server. The first web server and the second web server can still provide personalized web pages, which fit users' favorite, with a small number of received web page requests.

In some embodiments of this invention, the first web page and/or the second web page may include a forwarding program for respectively driving the first client device and the second client device to transmit the first information request and the second information request to the third party sharing-information server. The forwarding program may take the form of JavaScript codes or any other type of program codes, which can drive the client devices to transmit data.

In some embodiments of step 106, the third party sharing-information server may obtain a first score of a related tag according to the first web request. The related tag may be a tag related to EventTags in the first web page request or any other type of related tag. Hence, the third party sharing-information server may capture the EventTags in the first web page request to perform analysis, such that the first score of the related tag can be obtained. The third party sharing-information server generates a second score according to the first score obtained according to the first web page request, and the user's preference profile can be updated according to the second score (step 106). For example, a present score of the related tag in the user's preference profile is obtained, and a calculation is performed according to the first score and the present score of the related tag in the user's preference profile to generate the second score, which is taken into consideration for update. Therefore, the complexity for updating the user's preference profile can be simplified.

Similarly, in some embodiments of step 116, the third party sharing-information server may obtain a third score of a related tag according to the second web request. Hence, the third party sharing-information server may generate a forth score according to the third score obtained according to the second web page request, and the user's preference profile can be updated according to the forth score (step 116). For example, a present score of the related tag in the user's preference profile is obtained, and a calculation is performed according to the third score and the present score of the related tag in the user's preference profile to generate the forth score, which is taken into consideration for update.

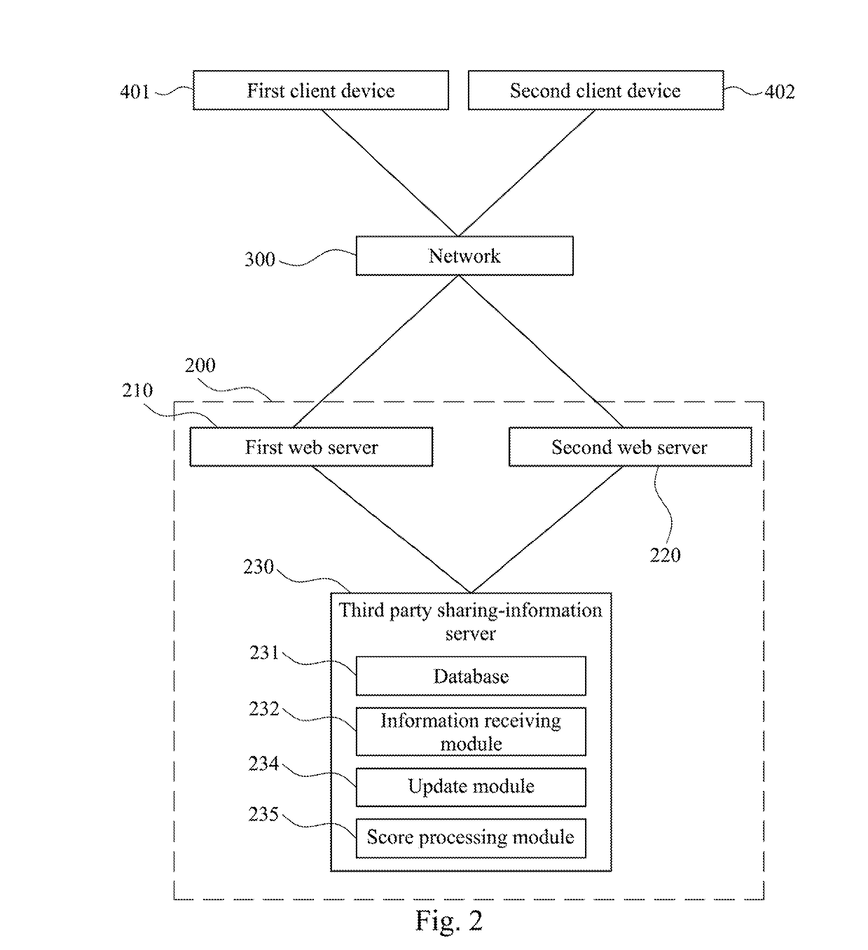

FIG. 2 illustrates a block diagram of a system for generating a personalized web page through a third party sharing-information server according to an embodiment of this invention. The system 200 includes a first web server 210, a second web server 220 and a third party sharing-information server 230. In some embodiments of this invention, the first web server 210 and the second web server 220 are in different domains. In another embodiments of this invention, the first web server 210 and the second web server 220 are different servers, which provide different web page services.

The first web server 210 and the second web server 220 connect to a network 300. The third party sharing-information server 230 builds connections with the first web server 210 and the second web server 220.

A user operates a first client device 401 to utilize identification information to log in the first web server 210 and to transmit a first web page request to the first web server 210 through the network 300. In other words, when a user wants to access a web page provided by the first web server 210, the user can operate the first client device 210 to transmit a corresponding first web page request, such that the first web server 210 receives the first web page request. The identification information may include an email account of the user, a telephone number of the user, an IMEI number of the first client device 401, a network address of the first client device 401, or a network hardware address of the first client device 401 or combination thereof. The network address of the first client device 401 may include an IP address of the first client device 401 or any other type of the network address of the first client device 401. The network hardware address of the first client device 401 may include a MAC address of the first client device 401 or any other type of the network hardware address of the first client device 401.

The user operates a second client device 402 to utilize the identification information to log in the second web server 220 and to transmit a second web page request to the second web server 220 through the network 300. The first client device 401 and the second client device 402 may be referred to as one single device or two independent devices. In other words, the user may operate a single client device or several different client devices to log in different web servers and access web pages provided by these web servers.

The third party sharing-information server 230 includes a database 231, an information receiving module 232 and an update module 234.

The information receiving module 232 receives a first information request and a second information request. The first information request is received from the first client device 401 operated by the user or the first web server 210, and the first information request includes the first web page request and the identification information for logging in the first web server 210. The second information request is received from the second client device 402 operated by the user or the second web server 220, and the second information request includes the second web page request and the identification information for logging in the second web server 220. The received identification information may include an email account of the user, a telephone number of the user, an IMEI number of the first client device 401 or the second client device 402, a network address of the first client device 401 or the second client device 402, or a network hardware address of the first client device 401 or the second client device 402 or combination thereof.

The update module 234 updates the user's preference profile stored in the database 231 according to the first information request and transmits the updated user's preference profile to the first web server 210. Hence, the first web server 210 transmits a first web page to the first client device 401 operated by the user according to the updated user's preference profile and the first web page request. Therefore, the first web page transmitted by the first web server 210 can fit the user's requirement.

The update module 234 updates the user's preference profile according to the second information request and transmits the updated user's preference profile to the second web server 220. Hence, the second web server 220 transmits a second web page to the second client device 402 operated by the user according to the updated user's preference profile and the second web page request. Therefore, even if the first web server 210 and the second web server 220 do not transmit received web page requests to each other, they can provide web pages, which fit users' favorite, with the assistance of the third party sharing-information server 230. The first web server 210 and the second web server 210 can still provide personalized web pages, which fit users' favorite, with a small number of received web page requests.

In some embodiments of this invention, the first web page and/or the second web page may include a forwarding program for respectively driving the first client device 401 and the second client device 402 to transmit the first information request and the second information request to the third party sharing-information server 230. The forwarding program may take the form of JavaScript codes or any other type of program codes, which can drive the client devices to transmit data.

The third party sharing-information server 230 may further include a score processing module 235. The score processing module 235 may analyze the first web request to obtain a first score of a related tag according to the first web request. The related tag may be a tag related to EventTags in the first web page request or any other type of related tag. Hence, the score processing module 235 may capture the EventTags in the first web page request to perform analysis, such that the first score of the related tag can be obtained. The score processing module 235 generates a second score according to the first score, and drives the update module 234 to update the user's preference profile. For example, the score processing module 235 may obtain a present score of the related tag in the user's preference profile, and then performs a calculation according to the first score and the present score of the related tag in the user's preference profile to generate the second score, which is taken into consideration for the update module 234 to perform update. Therefore, the complexity for updating the user's preference profile can be simplified.

Similarly, the score processing module 235 may obtain a third score of a related tag according to the second web request. The score processing module 235 generates a forth score according to the third score and drive the update module 235 to update the user's preference profile according to the forth score.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for generating a personalized web page through a third party sharing-information server, comprising:
operating a first client device by a user to log in a first web server with identification information and to transmit a first web page request to the first web server;
receiving a first information request by a third party sharing-information server, wherein the first information request is received from the first client device or the first web server, and the first information request comprises the first web page request and the identification information;
updating the user's preference profile by the third party sharing-information server according to the first information request;
transmitting the updated user's preference profile to the first web server by the third party sharing-information server;
transmitting a first web page to the first client device by the first web server according to the updated user's preference profile and the first web page request;
operating a second client device by the user to log in a second web server with the identification information and to transmit a second web page request to the second web server, wherein the first client device and the second client device are referred to as one single device or two independent devices;
receiving a second information request by the third party sharing-information server, wherein the second information request is received from the second client device or the second web server, and the second information request comprises the second web page request and the identification information;
updating the user's preference profile by the third party sharing-information server according to the second information request;
transmitting the updated user's preference profile to the second web server by the third party sharing-information server; and
transmitting a second web page to the second client device by the second web server according to the updated user's preference profile and the second web page request.

2. The method for generating a personalized web page through a third party sharing-information server of claim 1, wherein the first web page and/or the second web page comprises a forwarding program for respectively driving the first client device and the second client device to transmit the first information request and the second information request to the third party sharing-information server.

3. The method for generating a personalized web page through a third party sharing-information server of claim 1, wherein the step of updating the user's preference profile by the third party sharing-information server according to the first information request further comprising:
obtaining a first score of a related tag by the third party sharing-information server according to the first web request; and
generating a second score by the third party sharing-information server according to the first score and updating the user's preference profile.

4. The method for generating a personalized web page through a third party sharing-information server of claim 1, wherein the step of the third party sharing-information server updating the user's preference profile according to the second information request further comprising:
obtaining a third score of a related tag by the third party sharing-information server according to the second web request; and
generating a forth score according to the first score by the third party sharing-information server and updating the user's preference profile.

5. The method for generating a personalized web page through a third party sharing-information server of claim 1, wherein the identification information is an email account of the user, a telephone number of the user, an International Mobile Equipment Identity (IMEI) number of the first or second client device, a network address, or a network hardware address.

6. A system for generating a personalized web page through a third party sharing-information server, comprising:
a first web server connecting to a network, wherein a user operates a first client device to utilize identification information to log in the first web server and to transmit a first web page request to the first web server through the network;
a second web server connecting to the network, wherein the user operates a second client device to utilize the identification information to log in the second web server and to transmit a second web page request to the second web server through the network, wherein the first client device and the second client device are referred to as one single device or two independent devices; and
a third party sharing-information server building connections with the first web server and the second web server, wherein the third party sharing-information server comprises:
a database;
an information receiving module configured to receive a first information request and a second information request, wherein the first information request is received from the first client device or the first web server, and the first information request comprises the first web page request and the identification information, the second information request is received from the second client device or the second web server, and the second information request comprises the second web page request and the identification information; and
an update module configured to update the user's preference profile stored in the database according to the first information request and to transmit the updated user's preference profile to the first web server, such that the first web server transmits a first web page to the first client device according to the updated user's preference profile and the first web page request,
wherein the update module updates the user's preference profile according to the second information request and transmits the updated user's preference profile to the second web server, such that the second web server transmits a second web page to the second client device according to the updated user's preference profile and the second web page request.

7. The system for generating a personalized web page through a third party sharing-information server of claim 6, wherein the first web page and/or the second web page comprises a forwarding program for respectively driving the first client device and the second client device to transmit the first information request and the second information request to the third party sharing-information server.

8. The system for generating a personalized web page through a third party sharing-information server of claim 6, wherein the third party sharing-information server further comprises:
a score processing module configured to obtain a first score of a related tag according to the first web request, to generate a second score according to the first score, and to drive the update module to update the user's preference profile.

9. The system for generating a personalized web page through a third party sharing-information server of claim 6, wherein the third party sharing-information server further comprises:
a score processing module configured to obtain a third score of a related tag according to the second web request, to generate a forth score according to the third score, and to drive the update module to update the user's preference profile.

10. The system for generating a personalized web page through a third party sharing-information server of claim 6, wherein the identification information is an email account of the user, a telephone number of the user, an International Mobile Equipment Identity (IMEI) number of the first or second client device, a network address, or a network hardware address, which is taken into consideration for updating.

11. A third party sharing-information server, wherein the third party sharing-information server builds connections with a first web server and a second web server, wherein a first client device is operated by an user to log in the first web server with identification information and to transmit a first web page request to the first web server; and a second client device is operated by the user to log in the second web server with the identification information and to transmit a second web page request to the second web server; and the first client device and the second client device are referred to as one single device or two independent devices, wherein the third party sharing-information server comprises:
a database;
an information receiving module configured to receive a first information request and a second information request, wherein the first information request is received from the first client device or the first web server, and the first information request comprises the first web page request and the identification information, the second information request is received from the second client device or the second web server, and the second information request comprises the second web page request and the identification information; and
an update module configured to update the user's preference profile stored in the database according to the first information request and to transmit the updated user's preference profile to the first web server, such that the first web server transmits a first web page to the first client device according to the updated user's preference profile and the first web page request,
wherein the update module updates the user's preference profile according to the second information request and transmits the updated user's preference profile to the second web server, such that the second web server transmits a second web page to the second client device according to the updated user's preference profile and the second web page request.

12. The third party sharing-information server of claim 11, further comprising:
a score processing module configured to obtain a first score of a related tag according to the first web request, to generate a second score according to the first score, and to drive the update module to update the user's preference profile.

13. The third party sharing-information server of claim 11, further comprising:
a score processing module configured to obtain a third score of a related tag according to the second web request, to generate a forth score according to the third score, and to drive the update module to update the user's preference profile.

14. The third party sharing-information server of claim 11, wherein the identification information is an email account of the user, a telephone number of the user, an International Mobile Equipment Identity (IMEI) number of the first or second client device, a network address, or a network hardware address, for a basis of the updating the user's preference profile.
